(19) United States
(12) Patent Application Publication
(10) Pub. No.: US 2026/0321643 A1
(43) Pub. Date: Oct. 15, 2026

(54) SECONDARY BATTERY AND METHOD OF MANUFACTURING THE SAME

(71) Applicant: TOYOTA JIDOSHA KABUSHIKI KAISHA, Aichi (JP)

(72) Inventor: Junta TAKASU, Nagoya-shi (JP)

(21) Appl. No.: 19/639,308

(22) Filed: Apr. 6, 2026

(30) Foreign Application Priority Data
Apr. 14, 2025 (JP) 2025-066277

(51) Int. Cl. H01M 4/587; H01M 4/02; H01M 4/04; H01M 10/0525

(52) U.S. Cl. CPC H01M 4/587; H01M 4/0404; H01M 10/0525; H01M 2004/021; H01M 2004/027

(57) ABSTRACT

A secondary battery may include a positive electrode and a negative electrode facing each other with a separator interposed therebetween. The negative electrode may include a current collector, a composite layer on the current collector containing graphite particles, and an adhesive layer between the composite layer and the separator. The composite layer may include a surface layer in contact with the adhesive layer and a main layer between the surface layer and the current collector. In an XRD profile of the main layer, a degree of orientation, defined as a ratio of an intensity of a (110) plane of a graphite crystal to an intensity of a (002) plane, may be 0.03 or greater. Graphite particles in the surface layer may have two particle size peaks, and particles in the main layer may have only a first particle size peak.

### CROSS REFERENCE TO RELATED APPLICATION

This application claims priority to Japanese Patent Application No. 2025-066277 filed on Apr. 14, 2025. The entire content of the priority application is incorporated herein by reference.

### TECHNICAL FIELD

The art disclosed herein relates to a secondary battery and a method of manufacturing a secondary battery.

### BACKGROUND ART

A negative electrode used in a secondary battery includes a conductive negative electrode current collector and a negative electrode composite layer located on the negative electrode current collector. The negative electrode composite layer contains graphite particles each having a layered crystalline structure. Charge-discharge function is achieved by interlayer metal ion insertion and extraction between the layers of the graphite particles. In view of this, technologies have been proposed that orient layer planes of graphite particles substantially perpendicular to a negative electrode current collector by utilizing the magnetic alignment property of the graphite particles (e.g., Japanese Patent Application Publication No. 2024-85026). The closer the orientation of layer planes of graphite particles is to being perpendicular to the negative electrode current collector, the more smoothly metal ions can be inserted into and extracted from between the layers of the graphite particles. This improves performance of the secondary battery.

### SUMMARY

A surface layer of a negative electrode composite layer is bonded to a separator via an adhesive layer. Magnetically aligning the graphite particles in the negative electrode composite layer increases angles formed between the surface planes of the graphite particles and the surface of the negative electrode current collector. Thus, the surface roughness of the surface layer of the negative electrode composite layer increases with magnetically aligned graphite particles, compared to without magnetically aligned graphite particles. This may negatively affect the bonding between the surface layer of the negative electrode composite layer and the separator.

The technology disclosed herein is embodied in a secondary battery. In a first aspect of the present technology, a secondary battery may comprise a positive electrode and a negative electrode facing each other with a separator interposed therebetween. The negative electrode may comprise a negative electrode current collector; a negative electrode composite layer located on the negative electrode current collector and containing graphite particles; and an adhesive layer located between a surface of the negative electrode composite layer and the separator. The negative electrode composite layer may comprise a surface layer in contact with the adhesive layer and a main layer located between the surface layer and the negative electrode current collector. In an XRD profile of the main layer, a degree of orientation, which is defined as an intensity ratio obtained by dividing an intensity of a (110) plane of a graphite crystal by an intensity of a (002) plane of the graphite crystal, may be 0.03 or greater. A particle size distribution of the graphite particles contained in the surface layer may have peaks at a first particle size and at a second particle size smaller than the first particle size. A particle size distribution of the graphite particles contained in the main layer may have a peak at the first particle size and may not have a peak at the second particle size.

According to the configuration above, the particle size distribution of the graphite particles contained in the surface layer has a peak at the first particle size as well as a peak at the second particle size smaller than the first particle size. That is, the surface layer contains a group of particles having the first particle size and another group of particles having the second particle size. This allows the particles having the second particle size to fill gaps between the particles having the first particle size. By filling the gaps between the particles having the first particle size with the particles having the second particle size, the surface roughness of the surface layer can be improved. Thus, the bonding between the surface layer of the negative electrode composite layer and the separator can be improved.

### BRIEF DESCRIPTION OF DRAWINGS

FIG. 1 is a perspective view of a secondary battery 1.

FIG. 2 is an exploded plan view of an electrode assembly 108.

FIG. 3 is a cross-sectional view of a negative electrode 114.

FIG. 4 is a measurement result of a particle size distribution in a surface layer 10A.

FIG. 5 is a measurement result of a particle size distribution in a main layer 10B.

FIG. 6 is a flowchart illustrating a manufacturing method of the secondary battery 1.

FIG. 7 is a diagram illustrating an example of a first paste preparation step.

FIG. 8 is a diagram illustrating steps S20 to S50.

FIG. 9 is a diagram illustrating steps S100 and S110.

FIG. 10 is a diagram illustrating a hot-pressing step.

FIG. 11 is a cross-sectional view of a negative electrode according to a first comparative example.

FIG. 12 is a cross-sectional view of a negative electrode according to a second comparative example.

### DETAILED DESCRIPTION

In a second aspect of the technology disclosed herein according to the first aspect above, a particle size distribution of the graphite particles contained in the surface of the negative electrode composite layer may have peaks at the first particle size and at the second particle size.

The configuration above allows the particles having the second particle size to fill gaps between the particles having the first particle size in the surface of the negative electrode composite layer, thereby improving the surface roughness of the negative electrode composite layer.

The technology disclosed herein is also embodied in a method of manufacturing a secondary battery. A third aspect of the technology disclosed herein is directed to a method of manufacturing a secondary battery in which a positive electrode and a negative electrode face each other with a separator interposed therebetween. The method may comprise applying a first paste that contains first graphite particles having a peak at a first particle size onto a surface of a negative electrode current collector to form a first layer; applying a second paste that contains second graphite particles having a peak at a second particle size smaller than the first particle size onto a surface of the first layer to form a second layer; applying an external magnetic field to the first layer and the second layer; and drying the first layer and the second layer after the external magnetic field has been applied to the first layer and the second layer.

According to the configuration above, the graphite particles are magnetically aligned while the first layer and the second layer are in fluid state. Thus, the second graphite particles can flow into gaps formed by the magnetic alignment of the first graphite particles. This improves the surface roughness.

In a fourth aspect of the technology disclosed herein according to the third aspect, a particle size distribution of the graphite particles contained in a surface of the second layer after the drying of the first layer and the second layer may have peaks at the first particle size and at the second particle size.

According to the configuration above, the particles having the second particle size can fill gaps between the particles having the first particle size in the surface of the second layer. This improves the surface roughness of the second layer.

In a fifth aspect of the technology disclosed herein according to the third or fourth aspect, a median diameter of the first graphite particles may be larger than a median diameter of the second graphite particles.

In a sixth aspect of the technology disclosed herein according to the fifth aspect, the median diameter of the first graphite particles may be in a range of 15 to 40 micrometers, and the median diameter of the second graphite particles may be in a range of 5 to 20 micrometers.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved secondary batteries and methods of manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

### EMBODIMENT

### Structure of Secondary Battey 1

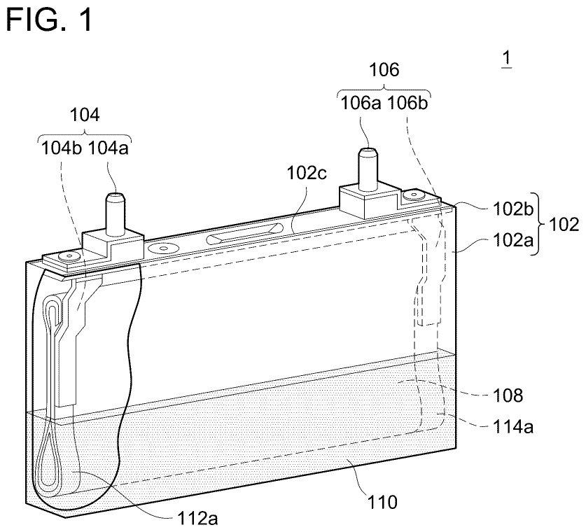

FIG. 1 is a perspective view of a secondary battery 1 according to an embodiment. In this embodiment, the secondary battery 1 is exemplified as a lithium-ion secondary battery. As illustrated in FIG. 1, the secondary battery 1 comprises a housing 102, a positive electrode terminal 104, a negative electrode terminal 106, an electrode assembly 108, and a non-aqueous electrolyte 110. The housing 102 houses the electrode assembly 108 and the non-aqueous electrolyte 110. The housing 102 comprises a housing body 102a and a cover plate 102b. The housing body 102a is an enclosure having an opening 102c in its upper portion. The cover plate 102b is attached to the opening 102c to close the opening 102c.

The positive electrode terminal 104 and the negative electrode terminal 106 are attached to the cover plate 102b. An end portion 104a of the positive electrode terminal 104 is exposed to the outside of the housing 102. The other end portion 104b of the positive electrode terminal 104 is connected to a positive electrode connecting portion 112a of the electrode assembly 108 within the housing 102. An end portion 106a of the negative electrode terminal 106 is exposed to the outside of the housing 102. The other end portion 106b of the negative electrode terminal 106 is connected to a negative electrode connecting portion 114a of the electrode assembly 108 within the housing 102.

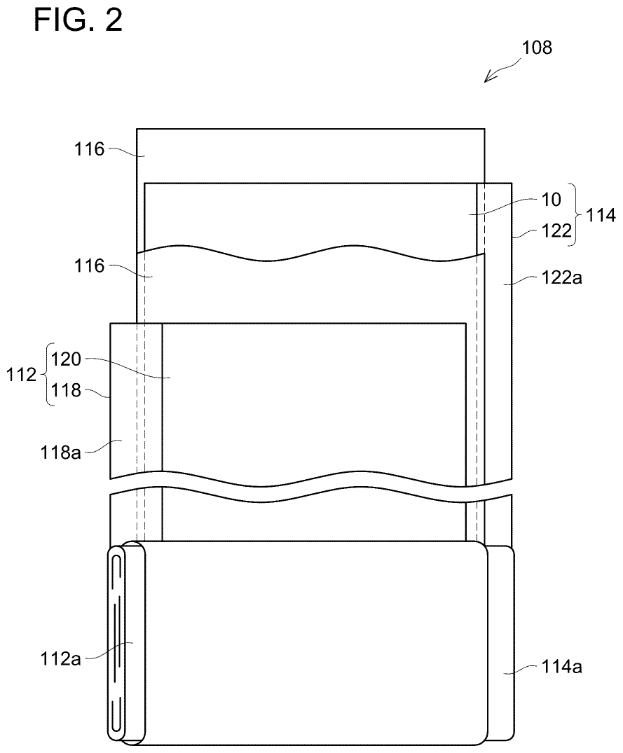

FIG. 2 is an exploded plan view of the electrode assembly 108. The electrode assembly 108 comprises a positive electrode 112, a negative electrode 114, and a separator 116. Each of the positive electrode 112, the negative electrode 114, and the separator 116 has an elongated sheet shape. The positive electrode 112 and the negative electrode 114 are stacked with the separator 116 interposed therebetween. The stack of the positive electrode 112 and the negative electrode 114 is rolled up to form the electrode assembly 108. However, the electrode assembly 108 is not necessarily a rolled electrode assembly. The electrode assembly 108 may, for example, be a so-called stacked electrode assembly in which multiple positive electrodes 112 and multiple negative electrodes 114 are alternately stacked with a separator 116 interposed between each pair of the positive electrode 112 and the negative electrode 114.

The positive electrode 112 comprises a positive electrode current collector 118 and a positive electrode active material sheet 120. The positive electrode current collector 118 is a conductive sheet. The positive electrode current collector 118 is, for example, an aluminum foil. The positive electrode active material sheet 120 is located on a surface of the positive electrode current collector 118. The positive electrode active material sheet 120 comprises a positive electrode active material. The positive electrode active material is, for example, a lithium composite oxide. The positive electrode 112 comprises a positive electrode exposure portion 118a in one of its widthwise side portions, and the positive electrode current collector 118 is exposed in the positive electrode exposure portion 118a. The positive electrode exposure portion 118a is rolled up in forming the electrode assembly 108 to form the positive electrode connecting portion 112a.

The negative electrode 114 comprises a negative electrode current collector 122 and a negative electrode composite layer 10. The negative electrode current collector 122 is a conductive sheet. The negative electrode current collector 122 is, for example, a copper foil. The negative electrode composite layer 10 is located on a surface of the negative electrode current collector 122. The negative electrode 114 will be detailed more specifically later. The negative electrode 114 comprises a negative electrode exposure portion 122a in one of its widthwise side portions, and the negative electrode current collector 122 is exposed in the negative electrode exposure portion 122a. The negative electrode exposure portion 122a is rolled up in forming the electrode assembly 108 to form the negative electrode connecting portion 114a.

The separator 116 is configured to allow charge carriers (i.e., lithium ions herein) to pass therethrough. Examples of the separator 116 include, for example, porous polymer films such as porous polyethylene films, porous polypropylene films, porous polyolefin films, and porous polyvinyl chloride films and lithium-ion-conductive polymer electrolyte membranes. One of these may be used as the separator 116, or some of these may be used in combination as the separator 16.

The non-aqueous electrolyte 110 permeates the interior of the electrode assembly 108. The non-aqueous electrolyte 110 comprises a non-aqueous solvent and an electrolyte salt. Examples of the non-aqueous solvent include, for example, carbonate-based solvents, ether-based solvents, ester-based solvents, nitrile-based solvents, sulfone-based solvents, and lactone-based solvents. The electrolyte salt is, for example, a fluorine-containing lithium salt. Each of the non-aqueous solvent and the electrolyte salt may comprise a single material or a combination of materials.

### Structure of Negative Electrode 114

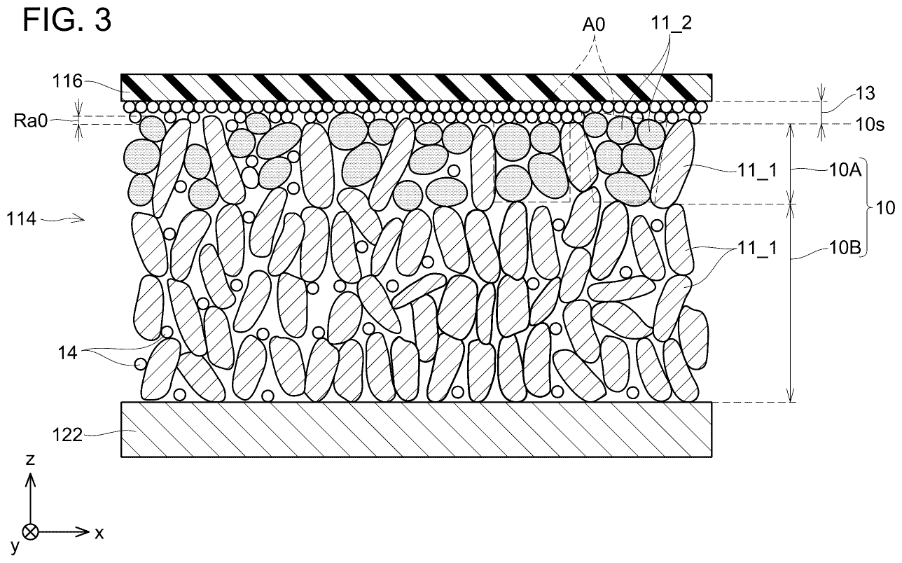

FIG. 3 illustrates a cross-sectional view of the negative electrode 114. FIG. 3 also illustrates the separator 116. In FIG. 3, directions parallel to the negative electrode current collector 122 are labeled as an x-direction and y-direction, and a direction perpendicular to the negative electrode current collector 122 (a thickness direction of the negative electrode 114) is labeled as a z-direction. For clarity of illustration, only one of a plurality of components may be labeled with a reference sign. This applies to all the drawings. The negative electrode 114 mainly comprises the negative electrode current collector 122, the negative electrode composite layer 10, and an adhesive layer 13.

The adhesive layer 13 is located between a surface 10s of the negative electrode composite layer 10 and the separator 116 to bond them each other. The adhesive layer 13 is a layer containing resin particles. In FIG. 3, the resin particles of the adhesive layer 13 are schematically depicted as white circles. Various materials may be used as the material of the adhesive layer 13. The material of the adhesive layer 13 may be the same as the material of a binder 14, which will be described later. In the present embodiment, the material of the adhesive layer 13 is the same PVDF as the material of the binder 14.

The negative electrode composite layer 10 is located on the negative electrode current collector 122. The negative electrode composite layer 10 comprises graphite particles 11, the binder 14, and a conductive additive (not illustrated). For the graphite particles 11, graphite-based carbon materials, such as natural graphite, synthetic graphite, or amorphous forms thereof, may be used. The graphite particles 11 may comprise, for example, flat flake graphite or spherical graphite obtained by sphering flake graphite. In the present embodiment, flake graphite is used as the graphite particles 11. This is because flake graphite can be stably aligned by application of magnetic field due to its flatness.

The binder 14 is a component to bind the graphite particles 11 together. The binder 14 is incorporated in the negative electrode composite layer 10. The binder 14 comprises resin particles. In FIG. 3, the binder 14 is schematically depicted as white circles. Examples of the binder 14 include, for example, polyvinylidene fluoride (PVDF), various acrylic-based resins, carboxymethyl cellulose (CMC), styrene-butadiene rubber (SBR), and polytetrafluoroethylene (PTFE). As the acrylic-based resins may be homopolymers obtained by polymerizing a single monomer, such as acrylic acid, methacrylic acid, acrylamide, methacrylamide, 2-hydroxyethyl acrylate, 2-hydroxyethyl methacrylate, methacrylate, methyl methacrylate, 2-ethylhexyl acrylate, and butyl acrylate. Alternatively, the acrylic-based resins may be copolymers obtained by polymerizing two or more of the above-listed monomers. The binder 14 may comprise a single material or a combination of materials. In the present embodiment, the material of the binder 14 is PVDF.

The negative electrode composite layer 10 comprises a surface layer 10A and a main layer 10B. The surface layer 10A is in contact with the adhesive layer 13. The main layer 10B is located between the surface layer 10A and the negative electrode current collector 122. The main layer 10B mainly comprises first graphite particles 11_1. In FIG. 3, the first graphite particles 11_1 are hatched. The surface layer 10A comprises second graphite particles 11_2 as well as the first graphite particles 11_1. In FIG. 3, the second graphite particles 11_2 are shaded gray.

The median diameter of the first graphite particles 11_1 is larger than the median diameter of the second graphite particles 11_2. The median diameter of the first graphite particles 11_1 is, for example, in the range of 15 to 40 micrometers. The median diameter of the second graphite particles 11_2 is, for example, in the range of 5 to 20 micrometers. The median diameter herein means the particle diameter (D50) at 50% cumulative volume in a volume-based particle size distribution measured by a laser diffraction/scattering method. In the present embodiment, the median diameter of the first graphite particles 11_1 is 20 micrometers, and the median diameter of the second graphite particles 11_2 is 10 micrometers.

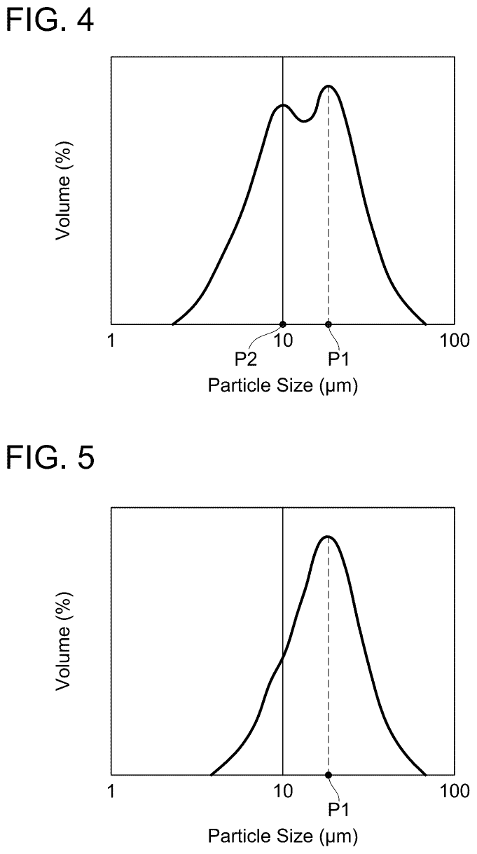

FIG. 4 illustrates a measurement result of particle size distribution in the surface layer 10A. FIG. 5 illustrates a measurement result of particle size distribution in the main layer 10B. FIGS. 4 and 5 illustrate volume-based particle size distributions measured by a laser diffraction/scattering method. In each of FIGS. 4 and 5, the horizontal axis represents particle size and the vertical axis represents volume percent. As illustrated in FIG. 4, the particle size distribution in the surface layer 10A has peaks (most frequent values) at a first particle size P1 and a second particle size P2. This is because the surface layer 10A includes both the first graphite particles 11_1 and the second graphite particles 11_2. In the example illustrated in FIG. 4, the first particle size P1 is approximately 20 micrometers and the second particle size P2 is approximately 10 micrometers. In contrast, as illustrated in FIG. 5, the particle size distribution in the main layer 10B has a peak at the first particle size P1 but does not have a peak at the second particle size P2. This is because the main layer 10B mainly includes the first graphite particles 11_1.

As above, the surface layer 10A and the main layer 10B can be distinguished from each other based on whether the particle size distribution has peaks at both the first particle size P1 and the second particle size P2 or not. That is, the boundary between the surface layer 10A and the main layer 10B can be defined based on their particle size distributions.

The surface layer 10A is exposed at the surface 10s of the negative electrode composite layer 10. Therefore, the particle size distribution at the surface 10s has peaks at the first particle size P1 and the second particle size P2, as illustrated in FIG. 4.

### Degree of Orientation of Graphite Particles

As described above, the graphite particles 11 comprise flat flake graphite. The flake graphite comprises a stack of numerous plate-shaped (graphene) layers each having a hexagonal crystal structure. Therefore, the graphite particles 11 each have a substantially plate shape. Further, the graphite particles 11 each comprise a (002) plane and a (110) plane. The (002) plane is a layer plane of the layered graphite particle (i.e., a plane parallel to graphite layers). The (002) plane is parallel to a carbon network of graphene sheets of the graphite particle 11. The (110) plane is an end plane of the layered graphite particle (i.e., a plane perpendicular to the graphite layers). The (110) plane is perpendicular to the (002) plane of the graphite particle. In other words, as illustrated in FIG. 3, each graphite particle 11 has an elongated shape in which the length in the direction parallel to the layer plane is greater than the length in the direction perpendicular to the layer plane.

Here, “degree of orientation” of the graphite particles 11 is defined as follows. The peak intensity derived from the (110) plane of the graphite particle 11 measured by powder X-ray diffraction (XRD) is denoted as PI1. The peak intensity derived from the (002) plane is denoted as PI2. The peak intensity PI1 is derived from the a-b axis direction of the graphite crystal. The peak intensity PI2 is derived from the c-axis direction of the graphite crystal. Then, the intensity ratio obtained by dividing the peak intensity PI1 by the peak PI2 is defined as the degree of orientation. That is, the degree of orientation=PI1/PI2.

A larger degree of orientation can be construed as meaning that there are more graphite particles 11 with their c-axes oriented parallel to the negative electrode current collector 122 (i.e., along the x-y plane in FIG. 3) in the negative electrode composite layer 10. That is, a larger degree of orientation means that the proportion of graphite particles 11 whose layer planes (longitudinal planes) are angled relative to the surface of the negative electrode current collector 122 is higher.

The inventors of the present invention have found that the degree of orientation in the main layer 10B is less than 0.03 when the magnetic alignment described below is not performed, and that the magnetic alignment can increase the degree of orientation in the main layer 10B to 0.03 or greater. That is, whether the magnetic alignment has been performed or not can be determined based on whether the degree of orientation in the main layer 10B is 0.03 or greater or not.

Here, the orientation difference between the first graphite particles 11_1 and the second graphite particles 11_2 is described. The second graphite particles 11_2 are smaller in the median diameter than the first graphite particles 11_1. Therefore, the aspect ratio of the second graphite particles 11_2 is smaller than that of the first graphite particles 11_1. In other words, the second graphite particles 11_2 are more spherical than the first graphite particles 11_1. Thus, the degree of orientation of the second graphite particles 11_2 is less than the degree of orientation of the first graphite particles 11_1 when the same magnetic field is applied thereto. That is, the second graphite particles 11_2 are less prone to magnetic alignment than the first graphite particles 11_1 are.

### Method of Manufacturing Secondary Battey

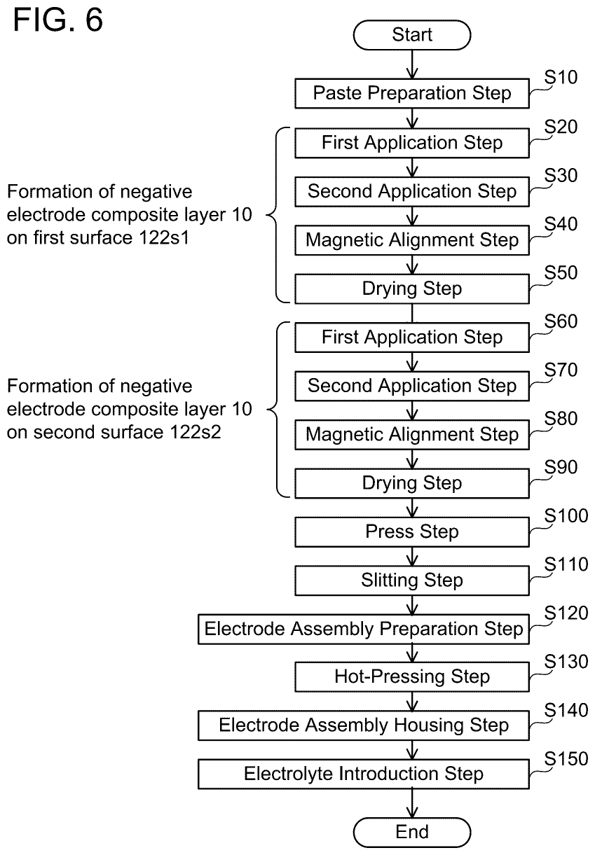

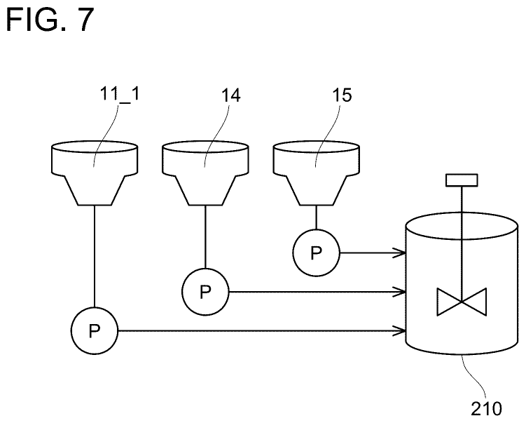

Referring to the flowchart illustrated in FIG. 6 and schematic diagrams illustrated in FIGS. 7 to 10, a method of manufacturing the above-described secondary battery is described. In step S10, a first paste and a second paste are prepared (paste preparation step). The first paste contains the first graphite particles 11_1. The second paste contains the second graphite particles 11_2. The pastes may be in the form of a slurry or an ink.

Referring to FIG. 7, an example of first paste preparation step is described. The first graphite particles 11_1, the binder 14, and the conductive additive 15 are introduced into a kneader 210 in respective predetermined amounts. A solvent is added to the materials in the kneader 210, and the mixture is kneaded to produce the first paste. The kneader 210 may be any type. For example, a planetary mixer may be used as the kneader 210. Similarly, in the second paste preparation step, a solvent is added to the second graphite particles 11_2, the binder 14, and the conductive additive 15, and the mixture is kneaded using the kneader 210.

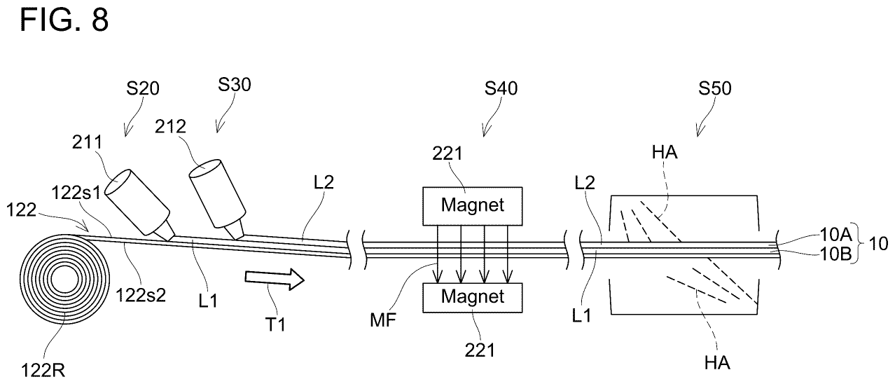

From step S20 to step S50, the negative electrode composite layer 10 is formed on a first surface 122s1 of the negative electrode current collector 122. These steps are specifically described referring to FIG. 8. In step S20, a first application step is performed. In the first application step, the first paste containing the first graphite particles 11_1 is applied onto the surface of the negative electrode current collector 122. Specifically, the negative electrode current collector 122 is fed out in a feed direction T1 at a constant speed from a roll 122R around which the negative electrode current collector 122 is wound. Then, the first paste is applied onto the negative electrode current collector 122 using a first coater 211. As a result, a first layer L1 is formed. The first coater 211 may be any type of coater. For example, the first coater 211 may be a slot-die coater.

In step S30, a second application step is performed. In the second application step, the second paste containing the second graphite particles 11_2 is applied onto the first layer L1. Specifically, the second paste is applied onto the first layer L1 using a second coater 212 which is disposed downstream of the first coater 211. As a result, a second layer L2 is formed on the first layer L1. The second coater 212 may be any type of coater.

In step S40, an external magnetic field is applied to the first layer L1 and the second layer L2 (magnetic alignment step). Specifically, a magnetic field whose magnetic flux lines MF are approximately perpendicular to the surface of the negative electrode current collector 122 is applied using a magnetic field generator 221. The magnetic field generator 221 may, for example, be a permanent magnet or an electromagnet. In this step, the (002) planes of the first graphite particles 11_1 are oriented substantially parallel to the magnetic flux lines.

In step S50, the first layer L1 and the second layer L2 are dried (drying step). Specifically, these layers are dried by blowing hot air HA thereto. The drying means used in the drying step is not limited to hot air and may be low-humidity air, vacuum, infrared radiation, far-infrared radiation, or electron-beam irradiation or any combination thereof. In the drying step, the solvents are removed from the first layer L1 and the second layer L2. As a result, the negative electrode composite layer 10 comprising the main layer 10B and the surface layer 10A is formed on the first surface 122s1 of the negative electrode current collector 122.

The particle size distribution of graphite particles at the surface of the second layer L2 after the drying step is similar to the above-described particle size distribution in the surface layer 10A (see FIG. 4). That is, the particle size distribution in the dried second layer L2 has peaks at the first particle size P1 and the second particle size P2.

From step S60 to step S90, the negative electrode composite layer 10 is formed on a second surface 122s2 of the negative electrode current collector 122. Since steps S60 to S90 are the same as steps S20 to S50 described above, detailed description thereof is omitted. As a result of steps S60 to S90, the negative electrode 114 is formed. The negative electrode 114 has a structure where the negative electrode composite layers 10 are located on both surfaces of the negative electrode current collector 122, respectively.

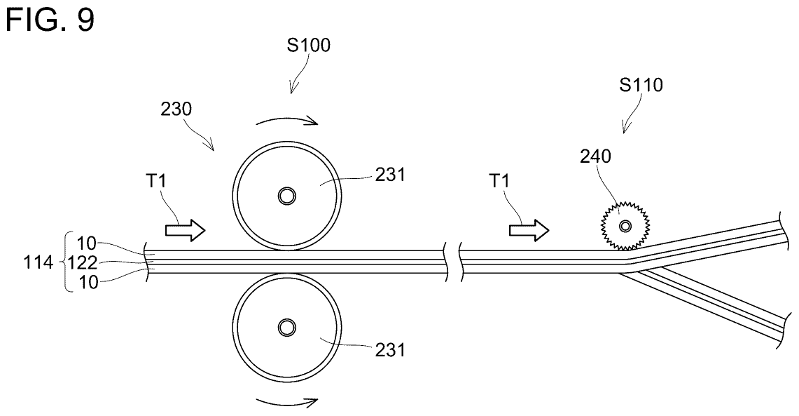

In step S100, the negative electrode 114 is pressed (press step). As illustrated in FIG. 9, a roll-press device 230 is used in the press step, although this is merely an example. The roll-press device 230 is configured to roll out the negative electrode 114 while it passes between a pair of rollers 231. The density and thickness of the negative electrode composite layers 10 can thereby be adjusted.

In step S110, slitting is performed. As illustrated in FIG. 9, during slitting, the negative electrode 114 is cut by a cutter 240 while fed in the feed direction T1. Thereby, the width of the negative electrode 114 in its transverse direction can be cut into the width corresponding to the size of the secondary battery 1.

In step S120, the electrode assembly 108 is prepared (electrode assembly preparation step). As illustrated in FIG. 2, in the electrode assembly preparation step, the positive electrode 112, the negative electrode 114, and the separator 116 are stacked on top of each other such that the positive electrode 112 and the negative electrode 114 face each other with the separator 116 interposed therebetween. Then, the stack of the positive electrode 112 and the negative electrode 114 is rolled up.

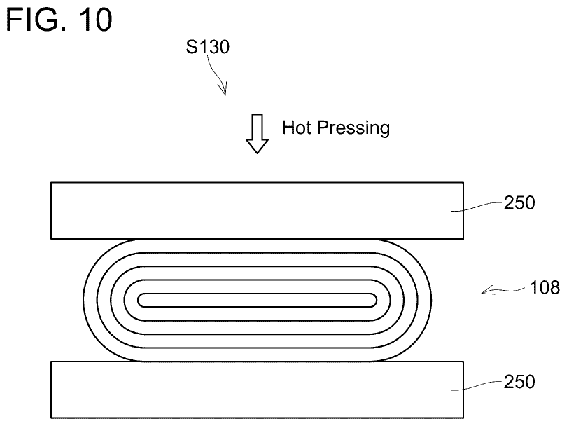

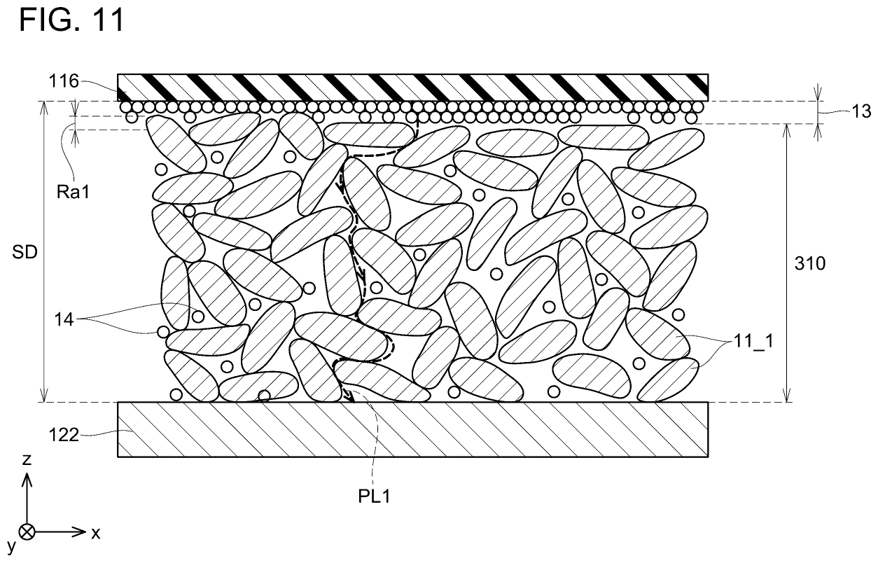

In step S130, the electrode assembly 108 is hot-pressed (hot-pressing step). As illustrated in FIG. 10, a flat platen press 250 is used in the hot-pressing step, although this is merely an example. Thereby, the electrode assembly 108 is compressed to have a flat shape having a predetermined thickness, and the separator 116 is bonded.

This hot-pressing step may be performed after an electrolyte introduction step (S150), which will be described later.

In step S140, an electrode assembly housing step is performed. Specifically, as illustrated in FIG. 1, the positive electrode terminal 104 and the negative electrode terminal 106 attached to the cover plate 102b are welded to opposing end portions of the electrode assembly 108, respectively. The electrode assembly 108 is housed into the housing body 102a through the opening 102c. Then, the housing body 102a and the cover plate 102b are bonded together, for example, by laser welding.

In step S150, the non-aqueous electrolyte is introduced into the housing 102 through an inlet (not illustrated) (electrolyte introduction step). Then, the inlet is hermetically sealed using a sealing member. As a result, the secondary battery 1 is completed.

### Problem

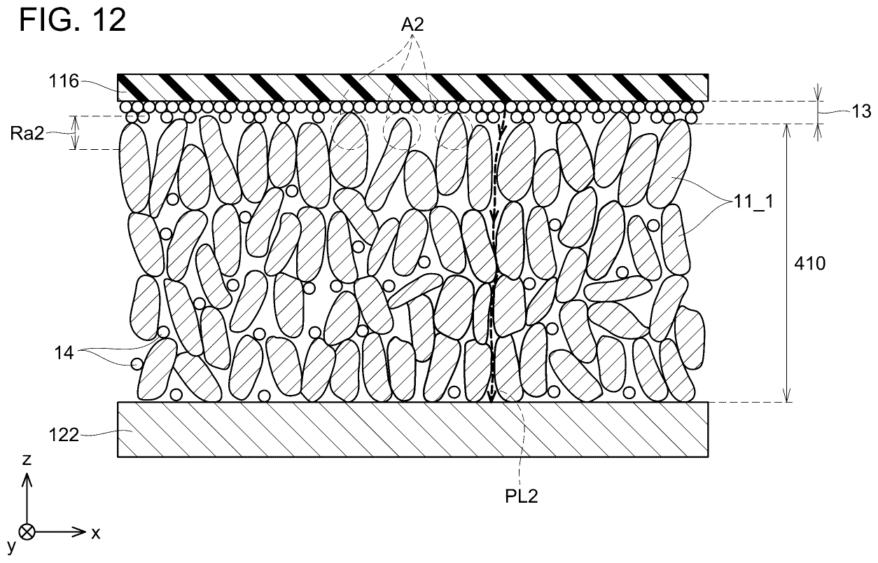

Referring to a first comparative example illustrated in FIG. 11 and a second comparative example illustrated in FIG. 12, a problem is described. FIGS. 11 and 12 illustrate cross-sectional views similar to FIG. 3. The first comparative example (FIG. 11) is different from the embodiment (FIG. 3) in that a negative electrode composite layer 310 comprises only the first graphite particles 11_1 and that the negative electrode composite layer 310 is not magnetically aligned yet. The second comparative example (FIG. 12) is different from the embodiment (FIG. 3) in that a negative electrode composite layer 410 comprises only the first graphite particles 11_1. The negative electrode composite layer 410 of the second comparative example is magnetically aligned.

The negative electrode composite layer 310 of the first comparative example (FIG. 11) is not magnetically aligned yet. Therefore, the surface planes (longitudinal planes) of the first graphite particles 11_1 are not oriented substantially perpendicular to the negative electrode current collector 122 (i.e., along the z-direction). Thus, a path length PL1 of pores from the separator 116 to the negative electrode current collector 122 is large. That is, the tortuosity in the negative electrode composite layer 310 is large. The tortuosity herein is defined as a ratio of the path length PL1 to a straight-line distance SD from the separator 116 to the negative electrode current collector 122. A larger tortuosity leads to less smooth insertion and extraction of Li ions into and from between the layers of the first graphite particles 11_1. Thus, a larger tortuosity increases internal resistance in the second battery 1 and impairs the performance of the secondary battery 1.

In contrast, the negative electrode composite layer 410 of the second comparative example (FIG. 12) is magnetically aligned. Therefore, the surface planes (longitudinal planes) of the first graphite particles 11_1 are oriented substantially perpendicular to the negative electrode current collector 122 (i.e., along the z-direction). Thus, a path length PL2 of pores in the second comparative example is shorter than the path length PL1 of pores in the first comparative example. That is, the tortuosity in the second comparative example is smaller than that in the first comparative example, which reduces the internal resistance. However, when the first graphite particles 11_1 are magnetically aligned, angles formed between the surface planes of the first graphite particles 11_1 and the surface of the negative electrode current collector 122 are larger. Thus, sharp end planes (i.e., (110) planes) of the first graphite particles 11_1 project upward from the surface of the negative electrode composite layer 410 (see areas A2). This makes a surface roughness Ra2 of the negative electrode composite layer 410 of the second comparative example greater than a surface roughness Ra1 of the negative electrode composite layer 310 of the first comparative example. Therefore, the bonding between the magnetically aligned negative electrode composite layer and the separator 116 may be worse than the bonding between the non-magnetically aligned negative electrode composite layer and the separator 116.

Various parameters may be used for the surface roughness Ra1 and the surface roughness Ra2. Herein, arithmetical mean roughness is used as surface roughness. The arithmetical mean roughness can be measured according to JIS B 0601:2001. The same applies to a surface roughness Ra0 which will be described later.

### Advantageous Effects

In the negative electrode composite layer 10 according to the embodiment (FIG. 3), the degree of orientation in the main layer 10B is 0.03 or greater. That is, the main layer 10B is magnetically aligned. Since the tortuosity in the main layer 10B is small, the internal resistance is reduced.

Further, the particle size distribution of the graphite particles 11 in the surface layer 10A has peaks at both the first particle size P1 and the second particle size P2. That is, the surface layer 10A comprises both the first graphite particles 11_1 corresponding to the peak at the first particle size P1 and the second graphite particles 11_2 corresponding to the peak at the second particle size P2. In other words, the larger first graphite particles 11_1 and the smaller second graphite particles 11_2 are distributed in the surface layer 10A. Thus, the smaller second graphite particles 11_2 can fill gaps between the sharp end planes of the larger first graphite particles 11_1 (see areas A0). By filling the gaps between the end planes of the first graphite particles 11_1 with the second graphite particles 11_2, the surface roughness Ra0 of the surface layer 10A can be improved. Thus, the bonding between the surface layer 10A and the separator 116 can be improved.

In the steps for forming the negative electrode composite layer 10 according to the embodiment, the magnetic alignment step (step S40) is performed after the application of the first layer L1 (step S20) and the application of the second layer L2 (step S30) and before the drying step (step S50). Thus, the magnetic alignment takes place while the first layer L1 and the second layer L2 are in fluid state. As described above, the second graphite particles 11_2 are less prone to magnetic alignmentthan the first graphite particles 11_1 are. Therefore, by applying a magnetic field to the first layer L1 and the second layer L2, the first graphite particles 11_1 in the first layer L1 can selectively be magnetically aligned. When magnetically aligned, the first graphite particles 11_1 form gaps between their end planes. By the second graphite particles 11_2, which are not magnetically aligned, flowing into these gaps, the surface roughness can be improved. Thereafter, the drying step is performed to form the surface layer 10A having improved surface roughness Ra0 (see FIG. 3).

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A secondary battery comprising a positive electrode and a negative electrode facing each other with a separator interposed therebetween,
wherein the negative electrode comprises:
a negative electrode current collector;
a negative electrode composite layer located on the negative electrode current collector and containing graphite particles; and
an adhesive layer located between a surface of the negative electrode composite layer and the separator,
wherein
the negative electrode composite layer comprises a surface layer in contact with the adhesive layer and a main layer located between the surface layer and the negative electrode current collector,
in an XRD profile of the main layer, a degree of orientation, which is defined as an intensity ratio obtained by dividing an intensity of a (110) plane of a graphite crystal by an intensity of a (002) plane of the graphite crystal, is 0.03 or greater,
a particle size distribution of the graphite particles contained in the surface layer has peaks at a first particle size and at a second particle size smaller than the first particle size, and
a particle size distribution of the graphite particles contained in the main layer has a peak at the first particle size and does not have a peak at the second particle size.

2. The secondary battery according to claim 1, wherein
a particle size distribution of the graphite particles contained in the surface of the negative electrode composite layer has peaks at the first particle size and at the second particle size.

3. A method of manufacturing a secondary battery in which a positive electrode and a negative electrode face each other with a separator interposed therebetween, the method comprising:
applying a first paste that contains first graphite particles having a peak at a first particle size onto a surface of a negative electrode current collector to form a first layer;
applying a second paste that contains second graphite particles having a peak at a second particle size smaller than the first particle size onto a surface of the first layer to form a second layer;
applying an external magnetic field to the first layer and the second layer; and
drying the first layer and the second layer after the external magnetic field has been applied to the first layer and the second layer.

4. The method according to claim 3, wherein
a particle size distribution of the graphite particles contained in a surface of the second layer after the drying of the first layer and the second layer has peaks at the first particle size and at the second particle size.

5. The method according to claim 3, wherein
a median diameter of the first graphite particles is larger than a median diameter of the second graphite particles.

6. The method according to claim 5, wherein
the median diameter of the first graphite particles is in a range of 15 to 40 micrometers, and
the median diameter of the second graphite particles is in a range of 5 to 20 micrometers.
